(19) United States
(12) Patent Application Publication
(10) Pub. No.: US 2009/0038651 A1
(43) Pub. Date: Feb. 12, 2009

(54) NO CONTACT CARWASH SYSTEM

(76) Inventor: Daniel Labrie, ST-Jean-Chrysostome (CA)

Correspondence Address: INVENTARIUM, SUITE 1607, 4050, ROSEMONT, MONTREAL, QC, H1X 1M4, CA

(21) Appl. No.: 11/837,540

(22) Filed: Aug. 12, 2007

(51) Int. Cl. B08B 3/02

(52) U.S. Cl. 134/95.3

(57) ABSTRACT

A no contact carwash system has a plurality of holding tanks which are connected to a dosing pump, one to each product to be mixed. The dosing pumps measuring quantities for each product. Water from a water line along with the products are then sent to a centrifuge pump for admixing into an admixture. Pressurised air is introduced to an air line and air from the air line and the admixture are blended into a lather generator and then fed to a spray line exiting through a spraying gun.

This application claims priority based on provisional application 60/836,910 filed Aug. 11, 2006

### FIELD OF THE INVENTION

The present invention relates generally to washing but more particularly to a system and method of washing a car without the need for scrubbing.

### BACKGROUND OF THE INVENTION

Car wash are a great invention but one problem has to do with the brushes that can get snagged in various parts of a vehicle such as a sports rack, antenna, rear view mirrors, trims, etc. Given the huge variety or car makes and models plus all the possible optional accessories, it is easier to find a way to eliminate brushes or direct contact with the vehicle rather than finding brushes that will not get caught. The problem with car wash offering a “no contact” washing feature is that they are not as efficient as a brush car wash.

Over the years, various inventions pertaining to the field of “no contact” car wash systems have been developed. In one such system, the surface of the car is first covered with a water soluble, agitated liquid cleaner which has been at least partially foamed. Then, the surface of the car is blasted with water soluble beads under sufficient pressure to apply a frictional cleaning motion to the liquid cleaner, but with insufficient pressure to damage the car surface by excessive abrasion. After the blasting step, the liquid cleaner and water soluble beads are rinsed by the application of a high pressure water spray to the vehicle.

Another invention describes a supporting frameworks wherein vehicles are parked and washed while they are stationary. Chemical lines supply chemicals (such as detergents, waxes, etc.) to water lines, and the chemicals and water are mixed in downstream mixing modules. The mixing modules are preferably provided in the form of vessels having enlarged flow areas, and may contain baffles or other turbulence generators therein. The chemical/water mixtures leave the mixing modules in post-mix lines to which gas supply lines may be connected for the purpose of generating foam, which is then delivered in the wash bay from a downstream delivery system. The downstream foam pressure has little or no effect on upstream mixing of chemicals and water, and thus foam having highly uniform properties is generated.

In yet another invention, fluid is conducted along a conduit that is mounted to a support structure so as to permit selected displacements thereof along a longitudinal axis of the conduit and selected rotations thereof about the longitudinal axis. The fluid conducted through the conduit can be conducted through at least one of a plurality of nozzles that are mounted to the conduit. The conduit is selectively reciprocated along the longitudinal axis by a first driving device. In addition, the conduit is rotated about the longitudinal axis by a second driving device. As the conduit is displaced both about and along the longitudinal axis, the fluid forced through the nozzle is directed toward the outside surface of an object to be washed.

Still another invention describes a car wash method which includes the steps of positioning a vehicle adjacent a set of sensors, measuring a variety of parametric data relating to macroscopic debris and surface film formed on a surface of the vehicle, calculating the quantity of presoak components to be added to a presoak solution, blending the presoak solution, and applying the presoak solution to the vehicle. Quantities of presoak enhancing agents are also calculated from the sensor readings along with the calculation of the number and type of wash cycles required for the vehicle. The method is implemented by customizable car wash blending system which incorporates a plurality of sensors in communication with a computer control system. Computer control system communicates with a series of sub-systems in order to apply the presoak solution and wash the vehicle.

Finally, there is even a car wash system that uses electromagnetic waves set between 100 nm et 2000 nm that break down the molecular structure of dirt particles.

### SUMMARY OF THE INVENTION

In view of the foregoing disadvantages inherent in the known devices now present in the prior art, the present invention, which will be described subsequently in greater detail, is to provide objects and advantages which are:

To attain these ends, the present invention generally comprises a plurality of holding tanks, each said holding tanks being connected to a dosing pump, one dosing pump to each product to be mixed. The dosing pumps measuring quantities for each product. Water from a water line along with the products are then sent to a centrifuge pump for admixing into an admixture. A pressure tank provides pressure controlled by a pressure relief valve the pressure then reduced by a reduction valve. The admixture traveling through an admixture line. Pressurised air introduced to an air line and air from that air line and the admixture blended into a lather generator and then fed to a spray line exiting through a spraying gun.

The lather is a specially formulated solution that creates a thick lather that traps and drags down the particles that soil the vehicle. A quick water rinse made after having the vehicle soak in the thick lather is all that is needed to wash and rinse the vehicle.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Schematic view of the process.

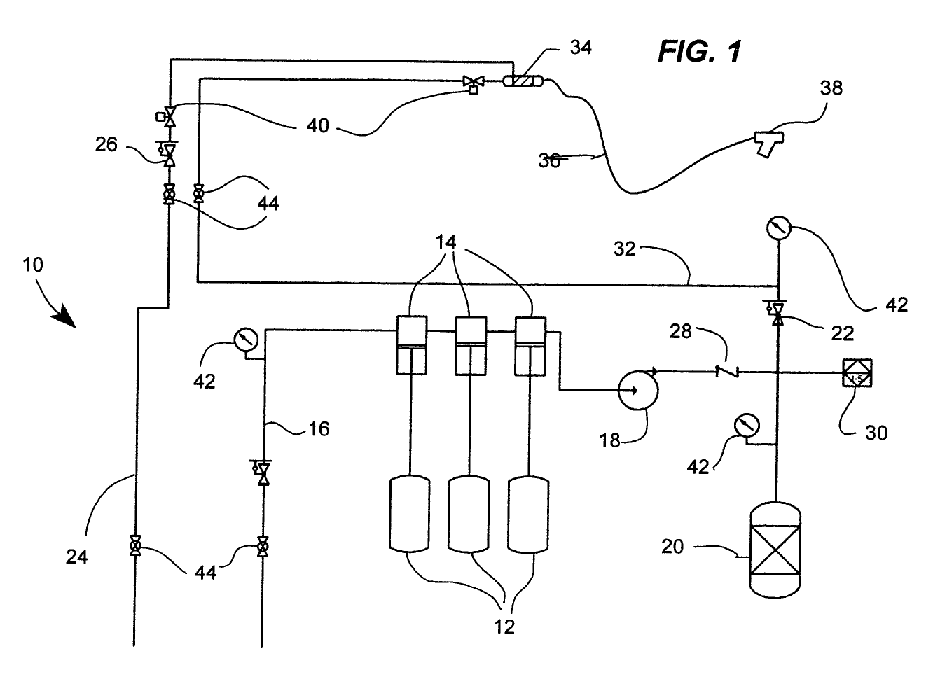

### DETAILED DESCRIPTION

A no contact carwash system (10) has a plurality of holding tanks (12), each one connected to a dosing pump (14). These dosing pumps (14) carefully measure the proper quantities for each product. Water from a water line (16) along with the products are then sent to a centrifuge pump (18) for admixing, the solution then passes through a check valve (28). A pressure tank (20) provides a pressure of between 100-120-psi which is controlled by a pressure relief valve (30) which maintains a pressure between 100-120 psi then reduced to about 80 psi by a reduction valve (22). From there, the admixture travels through an admixture line (32). In parallel, pressurised air is also introduced to an air line (24), reduced to about 75-85 psi by an air reduction valve (26). Air from the air line (24) and the admixture from the admixture line (32) are blended into a lather generator (34) and then fed to a spray line (36) exiting through a spraying gun (38).

Solenoid valves (40) located at various location provide control over the flow of the admixed solution. There are also a number of valves (44) to control the flow as well as pressure gauges (42) to monitor pressure throughout the no contact carwash system (10).

The lather thus created by the no contact carwash system (10) with the use of proprietary ingredients is very thick and as the lather slowly slides downward by the action of gravity, it breaks down the static on the vehicle so that dirt particles no longer cling to the vehicle. After a while, a rinse clears off the lather and the dirt with it.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A no contact car wash system comprising:
a plurality of holding tanks;
each said holding tanks being connected to a dosing pump, one said dosing pump to each product to be mixed;
said dosing pumps measuring quantities for each product;
water from a water line along with said products are then sent to a centrifuge pump for admixing into an admixture;
a pressure tank provides pressure controlled by a pressure relief valve said pressure then reduced by a reduction valve;
said admixture traveling through an admixture line;
pressurised air introduced to an air line and;
air from said air line and said admixture blended into a lather generator and;
then fed to a spray line exiting through a spraying gun.

2. A no contact car wash system as in claim 1 wherein:
lather slides downward by the action of gravity,
the lather breaks down the static on the vehicle so that dirt particles no longer cling to the vehicle.
